(19) United States
(12) Patent Application Publication
(10) Pub. No.: US 2018/0339215 A1
(43) Pub. Date: Nov. 29, 2018

(54) VIRTUAL REALITY TRAINING SYSTEM FOR TEAM SPORTS

(71) Applicant: National Cheng Kung University, Tainan City (TW)

(72) Inventors: Min-Chun Hu, New Taipei City (TW); Ming-Fen Chung, Miaoli County (TW); Wan-Lun Tsai, Taipei City (TW); Tse-Yu Pan, New Taipei City (TW); Yu-Lun Hsu, Taoyuan City (TW)

(21) Appl. No.: 15/823,479

(22) Filed: Nov. 27, 2017

(30) Foreign Application Priority Data
May 24, 2017 (TW) 106117133

(51) Int. Cl. A63B 71/06; G09B 19/00; G06F 3/01; H04N 13/04

(52) U.S. Cl. CPC A63B 71/0622; G09B 19/0038; G06F 3/012; A63B 2071/0638; A63B 2071/0636; A63B 2071/063; H04N 13/0429

(57) ABSTRACT

A virtual reality (VR) training system for a team sport, which implements tactical training in a VR environment. A server generates VR content based on target trajectories of a trainee in a tactic. A VR device (e.g., including a VR head-mounted display) receives the VR content to display the virtual environment and instructs the trainee to practice the target trajectories. The VR device further provides a motion sensor device that detects and returns the head pose, actions, and positions of the trainee to the server. The server updates the VR content according to the head pose, actions, and positions of the trainee. The target trajectories are further marked with timing and head orientation to instruct the trainee when to execute each trajectory and where to look for catching ball opportunity.

### CROSS REFERENCE TO RELATED APPLICATIONS

This Application claims priority of Taiwan Patent Application No. 106117133, filed on May 24, 2017, the entirety of which is incorporated by reference herein.

### BACKGROUND OF THE INVENTION

### Field of the Invention

The present invention relates to virtual reality technology.

### Description of the Related Art

In team sports such as basketball, tactical exercises are an important component of training players. Usually, a tactical board is used, on which the target trajectories of the players are marked to show the players how to exercise a tactic on the court or field. However, such a traditional manner of training can be hard to understand and is not very effective. Furthermore, practice on the court requires the full attendance of all players. Traditional tactical training is not ideal.

### BRIEF SUMMARY OF THE INVENTION

A virtual reality (VR) training system for team sports is disclosed in the disclosure, which implements tactical exercises in a VR environment.

A VR training system for team sports in accordance with an exemplary embodiment of the disclosure comprises a server and a VR device. The server generates VR content based on a target trajectory of a trainee for exercising a tactic. The VR device receives the VR content from the server to establish a VR environment to guide the trainee to practice the target trajectory. The VR device further detects and returns head orientation, player action and location of the trainee to the server. The server further modifies the VR content based on information returned from the VR device. The target trajectory is annotated to contain execution time points to train moves of the trainee. The target trajectory may be further annotated to contain a target orientation of the trainee to train the sightline of the trainee (to indicate the trainee where to look).

In an exemplary embodiment, the VR training system further includes an electronic tactical board. The electronic tactical board provides a user interface for a user to input the tactic. The user interface may further provide options for tactic modification and tactic searching.

In an exemplary embodiment, the VR training system further establishes a defensive model to operate the VR device to present virtual defenders in the VR environment. The defensive model may be strengthened by artificial intelligence learning.

In an exemplary embodiment, the VR training system further includes a VR head-mounted display and at least one motion or location sensor. The VR head-mounted display communicates with the server by a wireless technique.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a virtual reality (VR) training system 100 for team sports in accordance with an exemplary embodiment of the disclosure;

FIG. 2 illustrates the virtual reality device 106 in accordance with an exemplary embodiment of the disclosure;

FIG. 3 illustrates the operational flow of the virtual reality training system 100 for team sports in accordance with an exemplary embodiment of the disclosure;

FIG. 4 is flow chart depicting how the artificial intelligence is implemented in the defensive model 114 in accordance with an exemplary embodiment of the disclosure; and

FIG. 5 is a flow chart illustrating the operation of the virtual reality device 106 in accordance with an exemplary embodiment of the disclosure.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

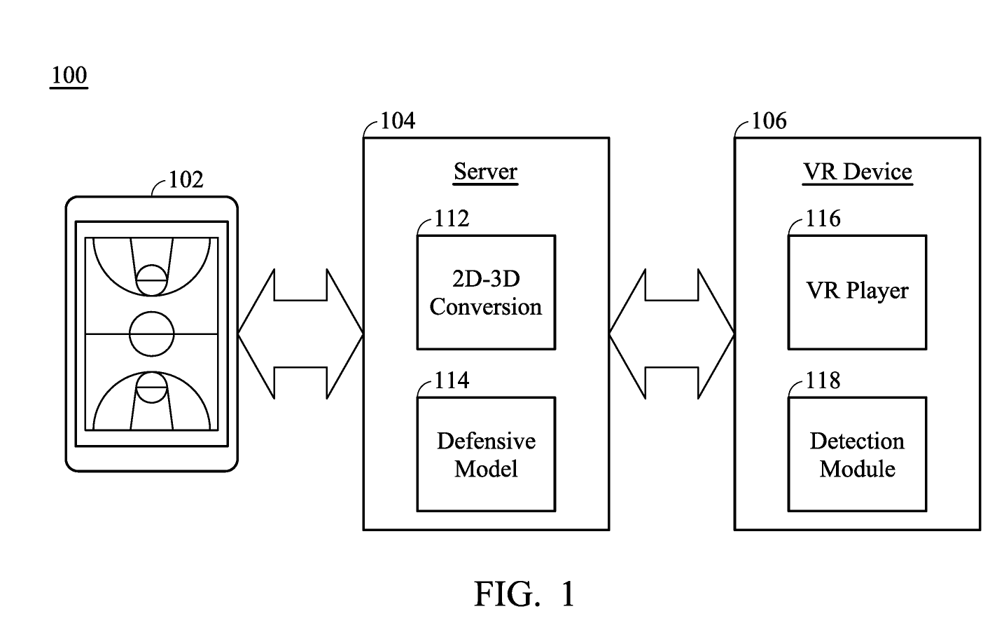

FIG. 1 depicts a virtual reality (VR) training system 100 for team sports in accordance with an exemplary embodiment of the disclosure, which includes an electronic tactical board 102, a server 104 and a virtual reality (VR) device 106. The sport of basketball is used by the way of illustration in the following examples, but the disclosure is not limited thereto.

The electronic tactical board 102 may be implemented as a tablet PC, a smartphone, a desktop machine, and the like, for input of tactics. The electronic tactical board 102 may have an input device such as a touch screen, a mouse and the like. The coach can draw the target trajectories of different players on the touch screen. In another exemplary embodiment, the target trajectories of different player are input by operating the mouse. Through the user interface provided on the electronic tactical board 102, execution time points, player actions and head orientations may be annotated to the target trajectories by the user. Not only to guide the trainee's offensive moves, the input tactics may further include viewing directions of players.

The electronic tactical board 102 communicates with the server 104. The tactics entered via the electronic tactical board 102 are uploaded to the server 104. The server 104 may use a computing unit with high computing capability to perform a 2D-3D conversion 112 and to establish a defensive model 114. A 2-dimensional target trajectory entered through the electronic tactical board 102 may be transformed to generate 3-dimensional information by the 2D-3D conversion 112 performed on the server 104. Virtual team members may be also presented in the corresponding positions in the VR environment to be seen by the trainee. Corresponding to the input tactic, the server 104 may further get data regarding virtual defenders from the defensive model 114 and, after the 2D-3D conversion 112, virtual defenders are presented in the VR environment.

The VR content (including 3D models, or even sound effects) generated by the server 104 may be passed to a virtual reality player 116 of the virtual reality device 106. According to the VR content provided from the server 104, the virtual reality player 116 displays VR scenes (possibly including sound effects) to the trainee. The virtual reality device 106 may further include a detection module 118. The detection module 118 detects and feeds back the motion of the trainee to the server 104. Based on the motion of the trainee, the server 104 updates and transmits the VR content to the virtual reality player 116. In a training mode, the trainee is able to exercise a tactic in a VR environment and practice the target trajectory to train the offensive moves and sightline repeatedly. In a self-test mode, the trainee may exercise the tactic to play against virtual defenders to check whether the trainee is skilled in the tactic.

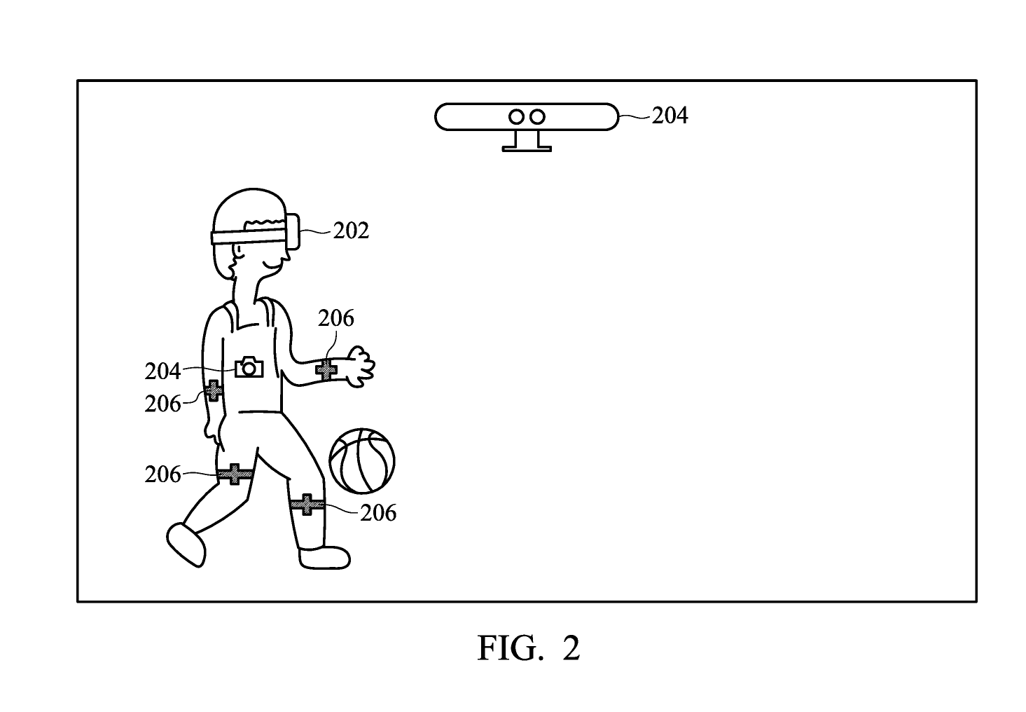

FIG. 2 illustrates the virtual reality device 106 in accordance with an exemplary embodiment of the disclosure. The trainee wears a virtual reality head-mounted display 202 which works as the virtual reality player 116 and displays VR scenes (possibly including sound effects). The offensive moves (e.g., dribbling, catching, or shooting) of the trainee may be detected by one or more sensors like the location sensor 204 or the motion sensors 206. The motion sensors 206 sense the movement of the trainee's limbs. In addition to displaying VR scenes (and optionally, sound effects), the virtual reality head-mounted display 202 detects the head movement of the trainee. In an exemplary embodiment, the virtual reality head-mounted display 202 detects the rotational accelerations around three axes and, accordingly, derives the head posture. The location sensor 204, the motion sensors 206, and the virtual reality head-mounted display 202 are combined to implement the detection module 118, and the detected data returns the server 104. The VR scenes (which may include sound effects) displayed via the virtual reality head-mounted display 202 change with the motions of the trainee. The virtual defenders in the VR scenes also change their defensive positions and attitudes in response to the motion of the trainee.

In an exemplary embodiment, the virtual reality head-mounted display 202 communicate wirelessly with the server 104. In this way, the trainee can dribble and run like on an actual court. Since a relatively large amount of VR content may be required, the communication between the server 104 and the virtual reality head-mounted display 202 may be implemented by a wireless streaming technology.

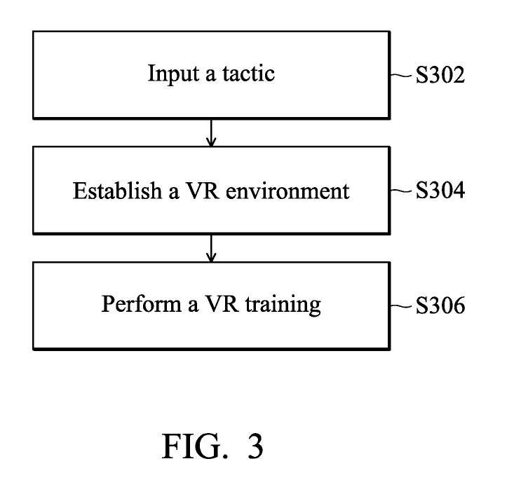

FIG. 3 illustrates the operational flow of the virtual reality training system 100 for team sports in accordance with an exemplary embodiment of the disclosure. In step S302, a tactic is input. The coach may input the target trajectories for different players via the electronic tactical board 102, wherein the target trajectories may be further annotated to contain execution time points, action guidelines, and target head orientations. In step S304, a VR environment is established. The server 104 performs the 2D-3D conversion 112 to transform the tactic uploaded from the electronic tactical board 102 to VR content, and transmits the VR content to the virtual reality device 106 to build the VR environment. In the VR environment, team members may be also presented for the trainee, and virtual defenders may be also presented based on the defensive model 114. In step S306, the VR training is performed. The trainee experiences the virtual reality via the VR player 116. The motions of the trainee are collected by the detection module 118 and are handed over to the server 104 to be reflected in the VR content in real time.

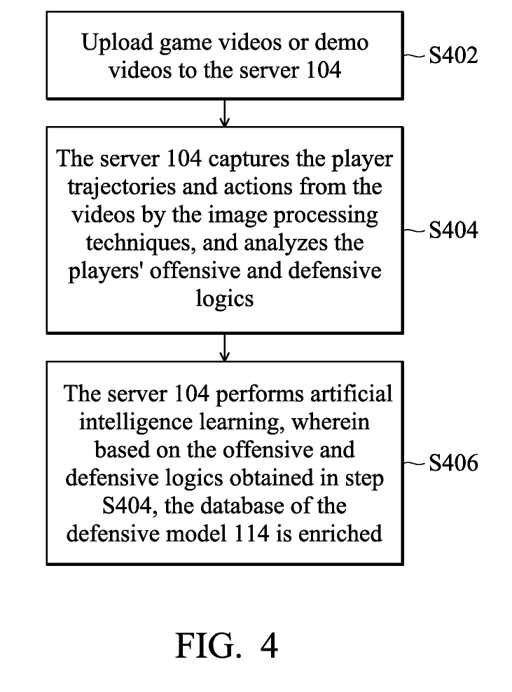

FIG. 4 is a flow chart depicting how the artificial intelligence is implemented in the defensive model 114 in accordance with an exemplary embodiment of the disclosure. In step S402, game videos or demo videos may be uploaded to the server 104. In step S404, the server 104 captures the player trajectories and actions from the videos by the image processing techniques, and analyzes the players' offensive and defensive logics. In step S406, the server 104 performs artificial intelligence learning. Based on the offensive and defensive logics obtained in step S404, the database of the defensive model 114 is enriched. The more videos input, the more realistic the defensive model 114.

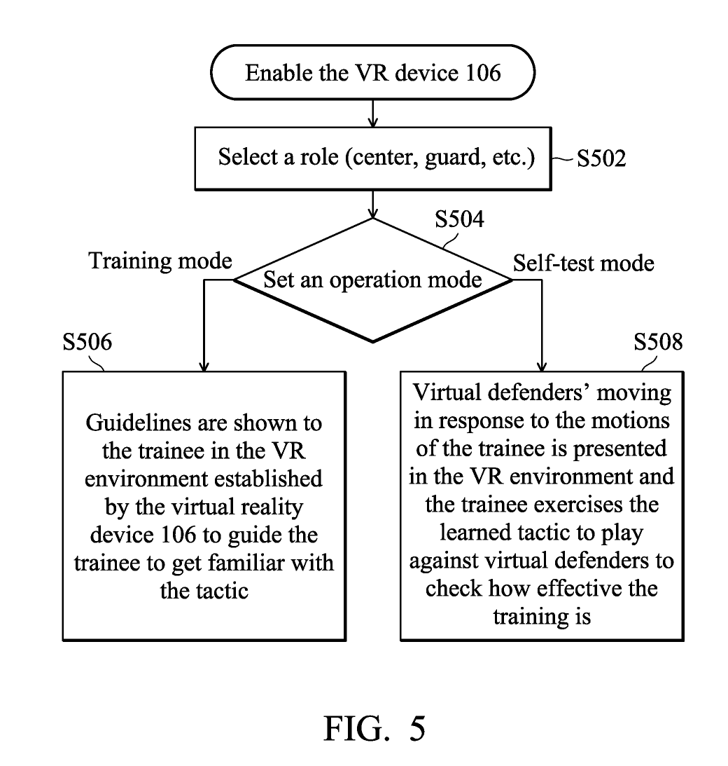

FIG. 5 is a flow chart illustrating the operation of the virtual reality device 106 in accordance with an exemplary embodiment of the disclosure. After enabling the virtual reality device 106, the trainee may select a role (center, guard, etc.) in step S502. In step S504, an operation mode is set. When a training mode is selected, step S506 is performed and guidelines are shown to the trainee in the VR environment established by the virtual reality device 106 to guide the trainee to get familiar with the tactic. In an exemplary embodiment, arrows or text hints are displayed in the VR environment to guide the offensive moves of the trainee and the expected orientation of the trainee's head (sightline guidance). In an exemplary embodiment, voice prompts are generated to guide the trainee. When self-test mode is selected, step S508 is performed. Virtual defenders' moving in response to the motions of the trainee is presented in the VR environment. The trainee exercises the learned tactic to play against virtual defenders to check how effective the training is.

The virtual reality training system 100 for team sports works well for just one single player and perfectly provides the sensation of being right there in the scene. Through the virtual reality training system 100, the players can be trained separately to get familiar with a tactic. The separately trained players can easily cooperate with their teammates to implement the tactic in an actual game.

The server 104 may be developed as an integration platform for tactics. The uploaded tactics can also be annotated with user annotations and organized into a database on the server 104. The server 104 may provide a search function. The annotations can be used in keyword search. In some exemplary embodiments, the server 104 may suggest an appropriate tactic corresponding to an input trajectory. The user may key in a keyword or input a trajectory via the electronic tactical board 102 to search the database on the server 104 to get a suggested tactic. In another exemplary embodiment, the server 104 is triggered to search the database for an appropriate tactic according to the detected location of the trainee (detected by the detection module 118). The server 104 may suggest relevant tactics for the trainee to select to start the training. In another exemplary embodiment, the server 104 is triggered to provide a tactic list based on the detected offensive moves of the trainee. The user can select a tactic from the tactics list.

In an exemplary embodiment, tactics are uploaded to server 104 by videos. Game videos or demo videos can be uploaded to the server 104 as input of tactics. The server 104 may use image processing techniques to capture the offensive moves or/and sightlines of the players and establish a VR training scenario accordingly.

In an exemplary embodiment, the electronic tactical board 102 also provides a modification function for the selected tactic. The electronic tactical board 102 will provide a user interface for modifications to the selected tactic to train the trainee with the modified tactic.

In an exemplary embodiment, the server 104 may change the viewing angle to adjust the VR content provided to the VR device 106. The trainee, therefore, can gain in-depth understanding of the offensive moves and sights of each player through the different perspectives, to being intuitively familiar with tactical details.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A virtual reality training system for team sports, comprising:
a server, generating virtual reality data based on a target trajectory of a trainee for exercising a tactic;
a virtual reality device, receiving the virtual reality data from the server to establish a virtual reality environment to guide the trainee to practice the target trajectory;
wherein:
the virtual reality device further detects head orientation, player action and location of the trainee to the server;
the server further modifies the virtual reality data based on information returned from the virtual reality device; and
the target trajectory is annotated to contain execution time points to train moves of the trainee.

2. The virtual reality training system as claimed in claim 1, wherein:
the target trajectory is further annotated to contain a target orientation of the trainee to train a sightline of the trainee.

3. The virtual reality training system as claimed in claim 1, further comprising:
an electronic tactical board, providing a user interface for a user to input the tactic.

4. The virtual reality training system as claimed in claim 3, wherein:
through the user interface provided on the electronic tactical board, respective target trajectories of different players are input by the user to be combined as the tactic.

5. The virtual reality training system as claimed in claim 1, wherein:
the server receives a video and processes the video to get target trajectories of different players.

6. The virtual reality training system as claimed in claim 5, wherein:
the server combines the target trajectories received from the video as the tactic.

7. The virtual reality training system as claimed in claim 5, further comprising:
an electronic tactical board, providing a user interface for a user to modify the target trajectories of the different players, wherein the modified target trajectories are combined as the tactic.

8. The virtual reality training system as claimed in claim 1, further comprising:
an electronic tactical board, for a user to key in a keyword or enter a trajectory to drive the server to search a database for the tactic.

9. The virtual reality training system as claimed in claim 1, wherein:
the server searches a database to select the tactic; and
the server searches the database according to a trajectory of the trainee detected by and returned from the virtual reality device.

10. The virtual reality training system as claimed in claim 1, wherein:
the server further establishes a defensive model to operate the virtual reality device to present virtual defenders in the virtual reality environment.

11. The virtual reality training system as claimed in claim 10, wherein:
the server changes trajectories of the virtual defenders when the tactic changes.

12. The virtual reality training system as claimed in claim 11, wherein:
the server obtains offensive and defensive logics from videos to strengthen the defensive model by artificial intelligence learning.

13. The virtual reality training system as claimed in claim 1, wherein:
the server further provides a 2D-3D conversion to generate the virtual reality data that is three-dimensional based on the target trajectory that is two-dimensional.

14. The virtual reality training system as claimed in claim 1, wherein the virtual reality device comprises:
a virtual reality player, displaying a virtual reality scene; and
a detection module, detecting motion and location of the trainee.

15. The virtual reality training system as claimed in claim 1, wherein:
the virtual reality device comprises a virtual reality head-mounted display and at least one motion or location sensor;
the virtual reality scene is displayed for the trainee by the virtual reality head-mounted display; and
the virtual reality head-mounted display is combined with the at least one motion or location sensor to detect the motion and location of the trainee.

16. The virtual reality training system as claimed in claim 15, wherein:
the virtual reality head-mounted display communicate with the server by a wireless technique.

17. The virtual reality training system as claimed in claim 15, wherein:
the virtual reality head-mounted display detects a head posture of the trainee;
the motion sensor detects the player action of the trainee; and
the location sensor detects moves of the trainee.

18. The virtual reality training system as claimed in claim 1, wherein:
the server guides moves of the trainee by presenting arrows, text hints, or voice prompts in the virtual reality environment.

19. The virtual reality training system as claimed in claim 1, wherein:
the server presents virtual reality team members in the virtual reality environment for the trainee.

20. The virtual reality training system as claimed in claim 1, wherein:
the server changes a viewing angle to change the virtual reality data to be displayed by the virtual reality device.
